(19) United States
(12) Patent Application Publication
(10) Pub. No.: US 2022/0361997 A1
(43) Pub. Date: Nov. 17, 2022

(54) PERIODONTAL PROBE AND METHODS OF READING PERIODONTAL POCKETS DEPTH

(71) Applicant: DENTAL SMARTMIRROR, INC., Chicago, IL (US)

(72) Inventors: Gidon Oded ELAZAR, Cohav Yair (IL); Dan Zidkiahu HARKABI, Moshav Lachish (IL); Joshua Israel WACHSPRESS, Modi'in (IL)

(73) Assignee: DENTAL SMARTMIRROR, INC., Chicago, IL (US)

(21) Appl. No.: 17/870,710

(22) Filed: Jul. 21, 2022

Related U.S. Application Data
(63) Continuation of application No. PCT/US2021/014901, filed on Jan. 25, 2021.
(60) Provisional application No. 62/965,584, filed on Jan. 24, 2020.

(51) Int. Cl. A61C 19/04

(52) U.S. Cl. CPC A61C 19/043

(57) ABSTRACT

Embodiments provide improved periodontal probes and an improved method of reading gum depth. In a first embodiment, a periodontal probe provides contrast by providing illumination directed towards the health care practitioner. In a second embodiment, a periodontal probe detects a gum depth by sensing a contrast in light. In a third embodiment, a computer-implemented method measuring depth of a pocket of a patient's gum.

### CROSS REFERENCE TO RELATED APPLICATIONS

This application is a continuation of International Application No. PCT/US2021/014901, filed on Jan. 25, 2021, which claims benefit of U.S. Provisional Application No. 62/965,584, filed on Jan. 24, 2020, which are hereby incorporated by reference herein in their entireties.

### BACKGROUND

### Field

This field is generally related to monitoring periodontal disease infecting the tissues around the teeth.

### Related Art

The gingiva, the tissue surrounding the teeth, is known as the gums. Generally, the top of the gingival tissue does not attach directly to the tooth. There is a small space between the tooth and gingiva known as gingival pocket, or periodontal pocket. The pocket can extend not only through bone. Bacteria and food particles may collect in that space, causing the space to widen. When gum tissue begins to separate or pull away from the teeth, it leaves a larger space between the tooth and gingiva, where harmful bacteria can thrive.

When pockets are too deep, such as greater than 3 mm in depth, they may pose increased danger to the tooth because brushing the teeth may fail to properly dislodge waste that has penetrated deep into the pocket. This may allow microbes to accumulate and cause the condition of the tissues to deteriorate even further, possibly damaging the bone. Ultimately, this process may even result in the compromised health of, and even loss of, the tooth. For that reason, health care practitioners measure pocket depths around each tooth regularly.

Periodontal probes are commonly made of metal and have two components: a handle that the health care practitioner uses to grasp the instrument and a tip portion that extends from the handle into a periodontal pocket. The tip portion connects to the handle and bends relative to the handle at around a 130 degrees angle to allow comfortable grasp and handling.

The tip portion has a ruler with a cylindrical shape (with a substantially circular cross-section) or a flat shape (with a substantially rectangular cross-section). The end of the ruler may be blunt to avoid puncturing the periodontium. The width at the end may be about 0.6 mm at its far end (ranging from 0.3 to 1 mm) to allow the probe to be able to reach the bottom part of the pocket. The ruler section of the tip has markings or shades denoting the distance from the tip end, such that the depth of the pocket can be measured by observing the markings or shades that remain out of the pocket.

To measure pocket depths, a health care practitioner, such as a dentist or hygienist, uses an instrument known as a periodontal probe. Typically, a health care practitioner inserts the probe into the pocket of a patient's gum and visually reads the pocket's depth from markings on the probe's ruler. Then, either the health care practitioner or another person enters the measurement into a patient's chart.

Many dental instruments are made of steel, but for reading pocket depths, steel has a disadvantage. With steel, the contrast, that is, the difference in luminance or color, between a probe's tip portion and its markings is frequently low. This low contrast makes harder the task of reading the depth of the pocket. This is particularly true when the oral cavity is dark.

In recent years, probes made out of plastic are available. Plastics allow for better contrast between the probe and its markings, but improved probes are needed.

### BRIEF SUMMARY

Embodiments provide improved periodontal probes and an improved method of reading gum depth. In a first embodiment, a periodontal probe provides contrast by providing illumination directed towards the health care practitioner. The periodontal probe includes a light source, a handle portion, and a tip portion. The handle portion is configured to enable a health care practitioner to grip the periodontal probe. The tip is portion configured to be inserted into a pocket of a patient's gum tissue, and includes a ruler and a light transmission medium. The ruler includes a plurality of markings configured such that, when the periodontal probe is inserted into the patient's gum tissue, the markings indicate a depth of the pocket of the patient's gum tissue. The light transmission medium is configured to transmit light emitted from the light source to an exterior surface of the tip portion and to direct the light toward the health care practitioner. The light providing contrast to read the markings.

In a second embodiment, a periodontal probe detects a gum depth by sensing a contrast in light. The periodontal probe includes a handle portion, a tip portion, and at least one light sensor. The handle portion is configured to enable a health care practitioner to grip the periodontal probe. The tip portion is configured to be inserted into a pocket of a patient's gum tissue. The tip portion includes a plurality of light transmission mediums. Each light transmission medium is set to receive light at a respective point along an exterior of the tip portion such that a number of light transmission mediums obscured by the patient's gum tissue corresponds to a depth of the pocket of the patient's gum tissue. The light sensor(s) is configured to detect light from the plurality of light transmission mediums.

In a third embodiment, a computer-implemented method measures depth of a pocket of a patient's gum. In the method, an image captured from an intraoral camera is received. The image was taken of a periodontal probe inserted into the patient's gum such that the periodontal probe includes a tip with a ruler comprising a plurality of markings. The image is analyzed, using a computer vision algorithm, to identifying which markings are obscured by the patient's gum. Based on the identified markings, the depth of the pocket of the patent's gum is determined.

System, device, and computer program product embodiments are also disclosed.

Further embodiments, features, and advantages of the invention, as well as the structure and operation of the various embodiments, are described in detail below with reference to accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1 is a diagram illustrating a periodontal probe with a translucent tip portion that conducts light from the handle.

FIG. 2 is a diagram illustrating a periodontal probe with fiber optic cables that conduct light from markings on a tip portion to a light sensor in the handle.

FIG. 3 is a diagram illustrating a periodontal probe's tip portion that has a printed circuit board within it.

FIG. 4 is a diagram illustrating a tip portion of a periodontal probe being inserted into a pocket of a gum.

FIG. 5A is a diagram illustrating an intraoral camera capturing an image of a periodontal probe being inserted into a pocket.

FIG. 5B is a diagram illustrating an image captured from an intraoral camera of a periodontal probe being inserted into a pocket.

FIG. 6 is a flowchart of a method for detecting pocket depth and recording it in a patient's chart.

The drawing in which an element first appears is typically indicated by the leftmost digit or digits in the corresponding reference number. In the drawings, like reference numbers may indicate identical or functionally similar elements.

### DETAILED DESCRIPTION

Embodiments provide improved periodontal probes and an improved method of reading pocket depth. In a first embodiment, a periodontal probe provides contrast by providing illumination directed towards the health care practitioner or towards an intraoral camera to support depth determination. In that embodiment, the periodontal probe may include markings that illuminate. The marks could be shaded or colored. The marks may emit light or obstruct light to create contrast. In the dark environment of the oral cavity, these illuminating marks will stand out and thus be easier to correctly identify. In this way, pocket depth may be more easily measured.

In a second embodiment, a periodontal probe, while inserted into a pocket, senses an amount of light reaching various locations of the ruler. To sense the light, fiber optics may connect different locations on the ruler to a light sensor. A computing device, either on the probe or elsewhere, determines where, on the ruler, light ends and darkness begins. Based on that, the computing device can determine a depth of the pocket.

In a third embodiment, a system, and its method of operation, measures the depth of a pocket of a patient's gum. A health care practitioner inserts a periodontal probe into a periodontal pocket. An intraoral camera, such as a camera embedded in a dental mirror, captures a video of the probing process. The video's set of successive images is processed to identify the tooth. They are processed to determine which tooth in the chart represents the tooth being measured (e.g. the tooth number) and to determine the depth of the pocket by analyzing the depth of the probe in the pocket. The chart is updated so an entry corresponding to the tooth being inspected shows the measurement. In this way, the depth of the pocket can be automatically determined and charted, and pocket depth can be more quickly and accurately read.

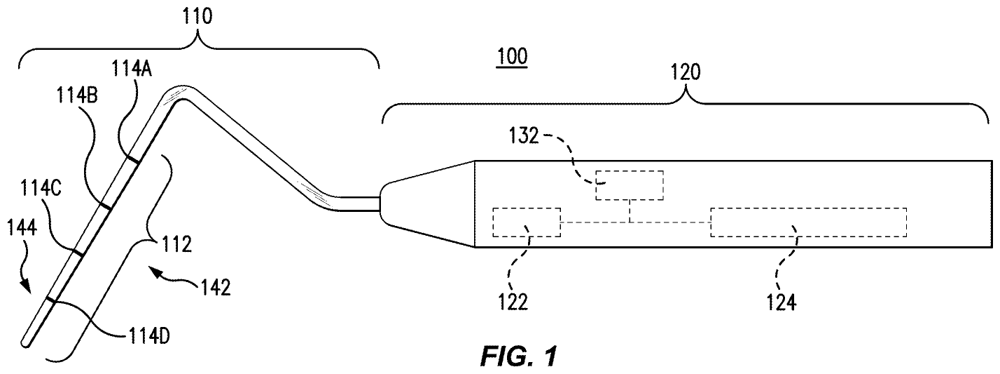

FIG. 1 is a diagram illustrating a periodontal probe 100 that provides contrast by providing illumination directed towards the health care practitioner. Probe 100 includes a tip portion 110 and handle 120.

Tip portion 110 is configured to be inserted into a pocket of a patient's gum tissue. Tip portion 110 includes a light transmission medium, or light pipe, configured to transmit light emitted from the light source to an exterior surface of the tip portion. The light provides contrast to read the markings. The light transmission medium may be a translucent or transparent material. For example, the light transmission medium of tip portion 110 may be made of a polycarbonate or optical acrylic construct, either flexible or rigid. In this way, the light transmission medium illuminates marks or shades that contrast with the dark environment of the oral cavity and thus will stand out and be easier to correctly identify.

Tip portion 110 includes a ruler 112 to allow a health care practitioner to read pocket depth. Ruler 112 includes markings 114A-D configured such that, when the periodontal probe is inserted into the patient's gum tissue, markings 114A-D indicate a depth of the pocket of the patient's gum tissue. In an embodiment, markings 114A-D may appear in regular segments (e.g. 0.5 mm). Alternatively or additionally, markings 114A-D may be a continuous spectrum of different colors.

Markings 114A-D may be applied using a coating on the light transmission material, such as the polycarbonate or optical acrylic. In an embodiment, the coating is applied to the light transmission material to block the light emitted from the light source preventing the light's emission to the exterior surface of tip portion 110 at each of markings 114A-D. In another embodiment, the coating is applied to the light transmission material to allow the light emitted from the light source to emit to the exterior surface of the tip portion at each of markings 114A-D.

As mentioned above, the coating used to make markings 114A-D may be colored. The coating may be translucent, or perhaps reflective, and may be colored such that each of markings 114A-D emits light in a different color. The various colors for markings 114A-D may be distinct from a color palette of the gum tissue. For example, to improve contrast, the palette from which the colors for the segment are chosen will avoid the colors common within the oral cavity, that is colors close to red, white, or pink are best avoided.

The coating may be applied on tip portion 110 such that the light is only directed toward the health care practitioner. Light may not be directed all the way around the probe. For example, tip portion 110 may have a reverse side 144 and an obverse side 142. There may be lateral sides that are between reverse side 144 and obverse side 142, either of which can face the tooth when inserted into the pocket depending on which side of the tooth is being measured. The coating may be applied such that obverse side 142 or reverse side 144 are solid, blocking most or all light, and markings 114A-D only appear on or about the lateral sides, which, while measuring depth, will be partially obscured by the gums or teeth. This is because, when measuring, the probe will usually be positioned so the handle is about parallel to the gum, and not orthogonal. This has the advantage of reducing ambient light within the mouth, thereby increasing contrast. While coating is described for illustrative purposes as a way to form the directional light, a skilled artisan would recognize other ways to do this. For example, the physical geometry of the probe could achieve this as well, e.g. colored translucent material over-molded with light blocking material.

In an embodiment, the light transmission medium in tip portion 110 may be a plurality of light pipes, such as fiber optic cables. Each fiber optic cable transmits light to one of markings 114A-D.

Handle 120 is a handle portion configured to enable a health care practitioner to grip the periodontal probe. Handle 120 may have an elongated shape, such as a cylinder, and may be hollow on the inside to conceal electronic components, including a light source 122, a power supply 124 and a power adjusting circuitry 132.

In an embodiment, light source 122 may be located within the handle portion. Light source 122 transmits light to the light transmission medium in tip portion 110 thereafter to an exterior of the tip portion. In an example, light source 122 is one or more light emitting diodes (LEDs). Light source 122 illuminates in the visible light spectrum, for example a light of similar color hues of daylight, which enables a visual perception (as well as capturing of images) of natural colors, or maybe a so-called “warm white” color which in some cases produces an illumination which is more comfortable to the human eye. In some embodiments, light source 122 illuminates in non-visible radiation, for example in a frequency within the infrared spectrum.

Alternatively, light source 122 may be located in the tip portion. Light source 122 may be small LED devices embedded into ruler 112. This may be accomplished for example by attaching each LED to a pair of wires. The set of such connected LEDs is overmolded with transparent or translucent material such as polycarbonate or optical acrylic to form a light transmission medium. The other ends of the wires may be connected to power supply 124 to produce light.

Handle 120 also includes power supply 124. Power supply 124 is connected to and configured to light source 122 and/or power adjusting circuitry 132 to power those devices. Power supply 124 may include batteries, such as AAAA batteries, or a capacitor.

Since a periodontal probe is in contact with a patient's mouth, the probe goes through sterilization after each treatment. In some cases, sterilization is done using a process known as “autoclaving.” Autoclaving subjects the mirror to high temperature and pressure, perhaps using steam.

To be autoclaved, a probe is generally placed in an autoclave machine, which is a pressure chamber used to carry out industrial processes requiring elevated temperature and pressure different from ambient air pressure. Many autoclaves are used to sterilize equipment and supplies by subjecting them to high-pressure saturated steam at 121-132° C. (249-270° F.) for around 15-20 minutes depending on the size of the load and the contents.

In an embodiment, tip portion 110 may be detachable from handle 120, and tip portion 110 may be autoclavable, while handle 120 may not. Handle 120 may include sensitive electronics and power supply 124 that could be damaged by the heat, pressure, and moisture in an autoclave machine.

In another embodiment, the tip and a portion of the handle, possibly with some of the electronic circuitry, may withstand autoclaving. For example, LEDs and the light sensor could be autoclaved in some circumstances. For example, the power supply 124 may be located in a detachable section of handle 120, possibly towards its end. This configuration may enable detachment of the battery prior autoclaving the probe, as batteries typically cannot be placed in such environmental conditions.

In yet another embodiment, tip portion 110 may be disposable for single use, avoiding the need for autoclaving.

Power adjusting circuitry 132 may be a simple contact or switch or a more sophisticated computing device that controls light source 122. Light source 122 may be configured to illuminate automatically when handle 120 is attached to tip portion 110. The illuminating probe 100 may or may not have a power button. In some embodiments, attaching the detachable section of the handle, thus attaching the battery, powers probe 100 and causes light source 122 to illuminate.

In some embodiments, a perforation (not shown) is present in proximity to light source 122 to allow for heat produced at light source 122 to dissipate into the environment around the probe. In some embodiments, a heat conductor, for example a metal structure, with one end in proximity to light source 122 and the other end exposed or in proximity to the surface of the probe, transfers heat from light source 122 into the environment.

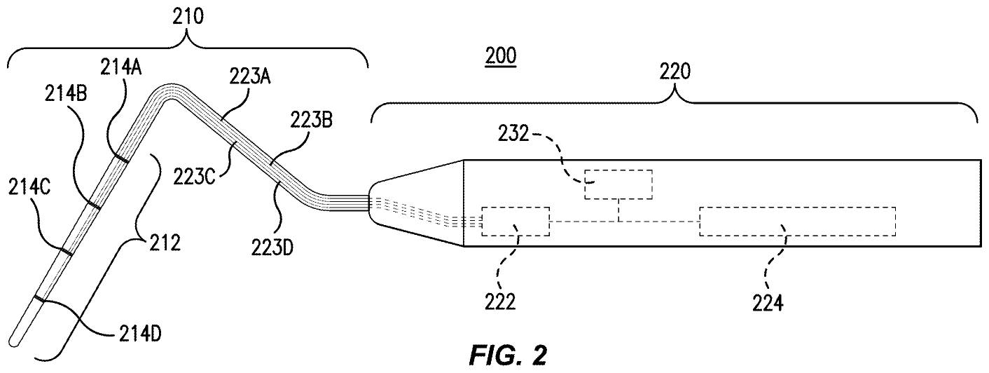

FIG. 2 is a diagram illustrating a periodontal probe 200 that detects a gum depth by sensing a contrast in light. Like probe 100 in FIG. 1, probe 200 includes a handle 220, configured to enable a health care practitioner to grip the periodontal probe, and power supply 224, one, a portion of either, or both of which can be detachable from a tip portion 210. Also like probe 100 in FIG. 1, probe 200 includes a tip portion 210, configured to be inserted into a pocket of a patient's gum tissue, which can be disposable or autoclavable.

Tip portion 210 includes a ruler 212 with markings 214A-D. Markings 214A-D may appear in regular intervals spaced lengthwise along tip portion 210. Markings 214A-D are on the exterior of tip portion 210 and are connected to light pipes 223A-223D. They allow light to pass through the exterior of tip portion 210 to light pipes 223A-223D.

Light pipes 223A-223D are each light transmission mediums, each set to receive light at markings 214A-D positioned at varying points along an exterior of the tip portion. Markings 214A-D are positioned such that, when tip portion 210 is inserted into a patient's gum, a number of light transmission mediums obscured by the patient's gum tissue corresponds to a depth of the pocket of the patient's gum tissue. In an example, each of light pipes 223A-223D may be a fiber optic cable.

Light sensor 222 detects light from light pipes 223A-223D. Light sensor 222 is a photoelectric device that converts light energy (photons) into an electrical (electrons) signal. Light sensor 222 generates an output signal indicating an intensity of light by measuring the radiant energy that exists in the range of electromagnetic frequencies called “light.” In an embodiment, probe 200 includes a plurality of light sensors 222, each configured to detect and measure light from a corresponding light pipe 223A-223D. In another embodiment, multiple light pipes 223A-223D can be multiplexed (such as with time division multiplexing) into a single light sensor 222.

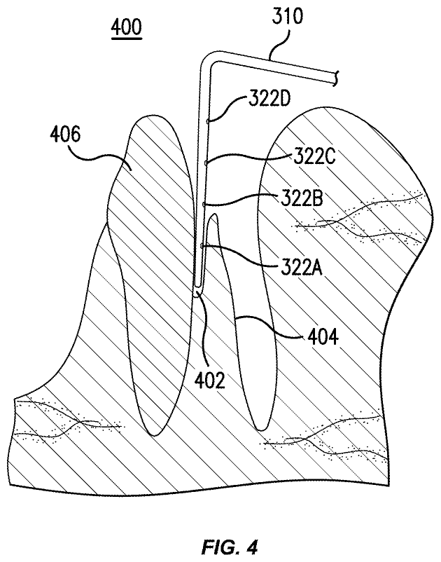

Computing device 232, powered by power supply 224, receives input from light sensor(s) 222 and uses that input to determine pocket depth. Computing device 232 is configured to (i) detect a contrast in intensity between adjacent light transmission mediums of the plurality of light transmission mediums and (ii) determine the depth of the pocket based on the detected contrast. This is illustrated in greater detail with respect to FIG. 4. While measuring pocket depth, light is present at the topmost locations of the ruler, then the gum starts to cover the light intake, and the light intensity reduces in the appropriate intakes and as the intake is further deep into the pocket light the less intensity is read. Thus as the probe is inserted into the pocket, progressively more of the sensors from the end of the tip and upwards will read lower intensities. Keeping track of this, for example tracking the topmost sensor that reads lower intensities, can be the basis for reading the depth. This is illustrated, for example with respect to FIG. 4.

FIG. 4 shows a tip portion 310 inserted into a pocket 402 between a gum tissue 404 and a tooth 406. Probe tip 310 has markings 322A-D, each connected to a light transmission medium and, in turn, to a light sensor. In a non-limiting example, markings 322A-D may include markings. Light is detected from markings 322B-D, but not from marking 322A, because light is obstructed by gum tissue 404. Hence, computing device 232 determines the measurement to be between marking 322A and marking 322B. In this way, computing device 232 is configured to determine the depth of the pocket based on the detected contrast such that the darker light transmission medium of adjacent light transmission mediums is within the pocket, and the lighter light transmission medium of the adjacent light transmission mediums is outside the pocket.

When the light sensor(s) determines that markings 322A-D all receive high intensity light, a computing device 332 can determine that the probe is not inserted into a pocket. That may be used to reset tracking values and to determine that a next, perhaps adjacent, tooth is to be charted. Alternatively, covering markings 322A-D will make the respective sensors read lower intensities, which can be used to set the progress tracking values, perhaps identifying that a patient's periodontal pocket measurements are complete, when a largest number of markings are determined as being covered.

In an alternative embodiment, the probe is also illuminating, and the effect is then reversed. In particular, the tip portion 310 further comprises a light source (not shown) positioned to emit light within pocket 402. The sensors reading intensity from marking 322A inside the pocket will read higher intensity, as the object being illuminated, gum tissue 404 in the pocket, is in close proximity and will substantially reflect light. Additionally, the sensor reading from marking 322A will show substantial presence of red color, originating in the light reflected from the tissue. This differential in brightness or color is used by computing device 232 to measure depth. In this way, computing device 232 is configured to determine the depth of the pocket based on the detected contrast such that the lighter light transmission medium of adjacent light transmission mediums is within the pocket, and the darker light transmission medium of the adjacent light transmission mediums is outside the pocket.

Alternatively or additionally, by comparing the amount of red component in adjacent light transmission mediums, such that the larger red component sensed by a light transmission medium of adjacent light transmission mediums is within the pocket, and the lower red component from a light transmission medium of the adjacent light transmission mediums is outside the pocket. This may be possible because the sensors at the opposite side of the tip, the side facing the tooth, and that may not be visible to the health care practitioner, measure mostly white color reflected from the tooth. The sensors on that side which are inside the pocket may measure more pronounced red hues reflected by the tooth from the gums, as compared to those outside the pocket which measure mostly white. Identifying this layout may also be used to determine that the probe is being now used for pocket depth measurement.

Returning to FIG. 2, computing device 232 can include, but is not limited to, a device having a processor and memory, including a non-transitory memory, for executing and storing instructions. The memory may tangibly embody the data and program instructions. Software may include one or more applications and an operating system. Hardware can include, but is not limited to, a processor, a memory, and a graphical user interface display. The computing device may also have multiple processors and multiple shared or separate memory components. To carry out its programmed functionality, computing device 232 may have various modules implemented in hardware, software, firmware, or any combination thereof.

Once computing device 232 determines a measurement, it outputs it. Computing device 232 may output the measurement to a display (not shown) on probe 200. Alternatively, computing device 232 may include a wireless transmitter and may output the measurement by transmitting it via, for example, WiFi or Bluetooth, to another device that presents it to the health care practitioner or records the measurement in the patient's dental chart. In an alternative embodiment, probe 200 may merely transmit measurements from light sensors to an external computer that calculates the pocket depth.

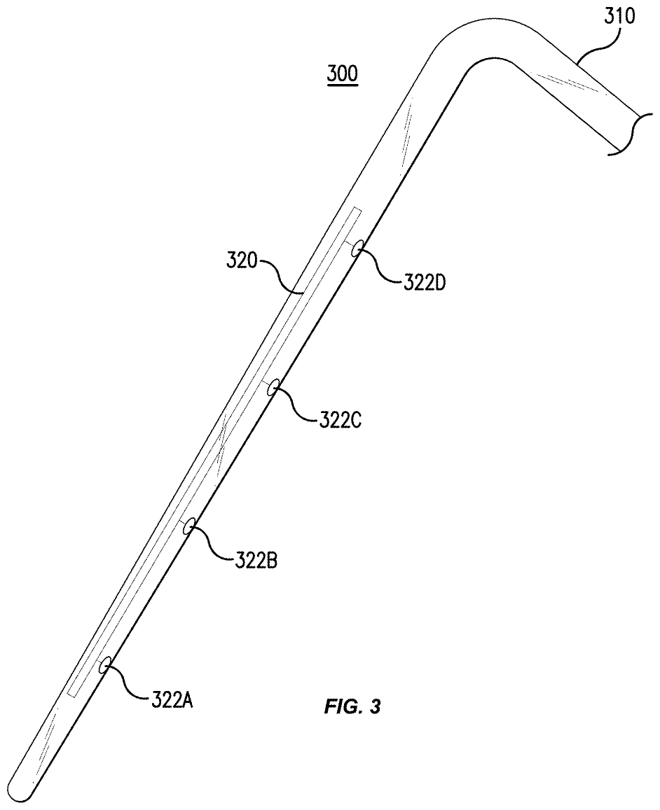

FIG. 3 is a diagram illustrating a periodontal probe's tip portion 310 that has a printed circuit board 320 within it. Printed circuit board 320 may include either the light sources, as in the embodiment illustrated in FIG. 1, or the light sensors, as in the embodiment in FIG. 2. In either case, the light transmission medium may be a window at each of markings 322A-D.

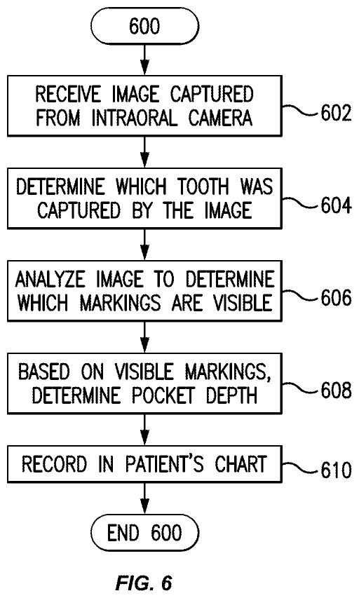

FIG. 6 is a flowchart of a method 600 for detecting pocket depth and recording it in a patient's chart. Note the methods for detecting which tooth is presently being examined may be applied to other cases where data needs to be recorded in a dental chart.

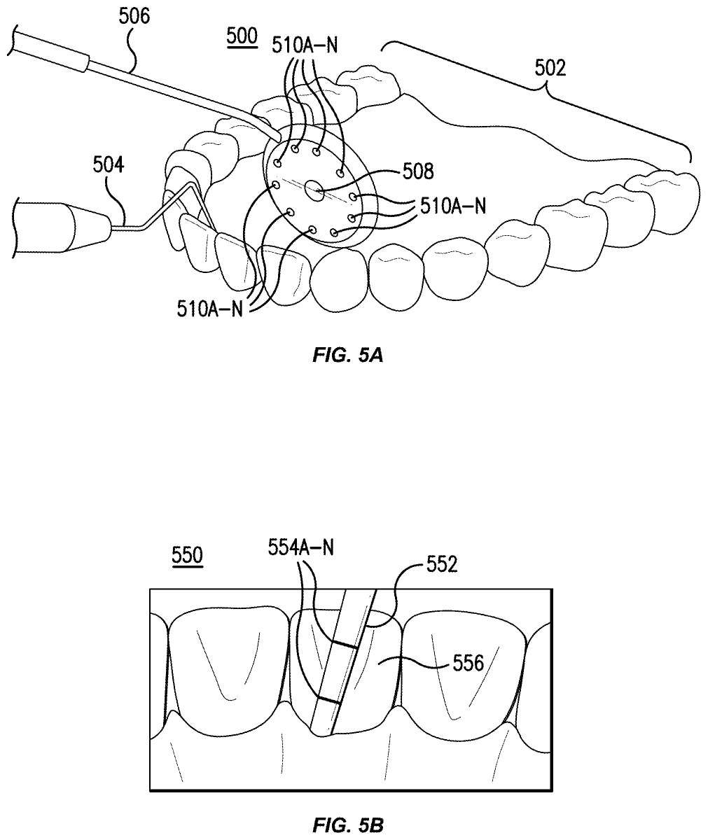

Method 600 begins at step 602 by receiving an image captured from an intraoral camera. The image is taken of a periodontal probe inserted into the patient's gum. In an embodiment, the intraoral camera may be affixed to a dental mirror as illustrated in FIG. 5A.

FIG. 5A is a diagram 500 illustrating a dental mirror 506 with an intraoral camera 508 capturing an image of a periodontal probe 504 being inserted into a pocket of a gum of a patient's mouth 502. Intraoral camera 508 may be an image sensor positioned to capture images that include at least some of the objects whose reflection can be observed by the health care practitioner in dental mirror. In this way, dental mirror 506 is positioned so that the health care practitioner can view periodontal probe 504 being inserted into a pocket of a gum.

Dental mirror 506 also includes a plurality of light sources 510A-N. Light sources 510A-N are affixed around the perimeter of dental mirror 506's reflective surface, and possibly concealed behind its reflective surface. Light sources 510A-N may illuminate the intraoral environment. In this way, light sources 510A-N can operate to improve the efficacy of the light sensor probe described with respect to FIG. 2.

In some embodiments, light sources 510A-N illuminate in the visible light spectrum, for example a light of similar color hues of daylight, which enables a visual perception (as well as capturing of images) of natural colors, or maybe a so-called “warm white” color, which in some cases produces an illumination which is more comfortable to the human eye. In some embodiments, light sources 510A-N illuminate in non-visible radiation, for example in a frequency within the infrared spectrum.

FIG. 5B is a diagram illustrating an image 550 captured from an intraoral camera of a periodontal probe being inserted into a pocket of a gum. Image 550 illustrates a periodontal probe 552 being inserted into a pocket of tooth 556. Image 550 can be one of a set of successive images of video streamed from an oral camera as part of step 602.

At step 604, a computing device identifies the specific tooth within the patient's mouth corresponding to the pocket into which the periodontal probe is inserted. To determine the tooth, various machine learning models may be used. For example, a classifier may be trained to recognize the tooth. The position and orientation of the intraoral camera may also be used as an input to help identify the tooth. Finally, the previous tooth measured may be used as an input to help determine the current tooth, because health care practitioners tend to measure teeth in sequential order.

Other techniques are available as well. The tooth can be identified by using a map; i.e. a panoramic photograph of the patient's mouth is generated from successive photos taken at the beginning of the session or at a previous session. Using segmentation techniques, the teeth in the panoramic are separated from each other, and thereafter numbered according to their order. Later, while measuring, images of the tooth being observed are matched within the map to identify its position within the photograph and from that position the appropriate tooth number is determined. Alternatively or additionally, a 3D model of the mouth is created using photometric stereo or dual camera stereo reconstruction, from that model is generated and used a map. Alternatively or additionally, an immersive photograph is used for the map.

In one embodiment, the tooth number could be determined by another image in the series of images from the video, one that the probe is not present. After the tooth number is identified, the tooth is tracked to ensure that that the tooth is what has the pocket that the health care practitioner probes.

Finally, the correct tooth number is assigned by the practitioner's indication. For example, the practitioner may speak the tooth number and the system recognizes the tooth, maybe by means of speech to text, or by allowing input by other means. The data from the images may be combined with practitioner input and used to train a model to classify teeth by numbers, gradually improving its accuracy.

At step 606, the image captured by the intraoral camera is analyzed, using a computer vision algorithm, to identifying which markings are obscured by the patient's gum. This may involve using an object detection algorithm, such as Viola-Jones object detection or scale-invariant feature transform (SIFT), to detecting that the probe is present in the image and to detect which markings on the probe are present in the image. The object detection techniques may be more accurate when used with the probe described with respect to FIG. 1, because the increased contrast and the variety of marking colors may make for more distinctive features.

At step 608, the depth of the pocket of the patent's gum is determined based on the markings identified in step 606. The more markings detected, the more shallow the gum depth. For example, turning to FIG. 1, if markings 114A and B are detected, but markings 114C and D are not, then the depth is determined to be the distance from the tip of the probe to between markings 114B and C. Since the distance between markings is a known, the algorithm may measure the distance between two adjacent markings in the image, for example by number of pixels. Then it may measure the distance between the gum and the closest visible mark, thereafter estimating the length of the probe section that is inside the pocket. Alternatively, the dimension of the markings are a known measure. The algorithm may measure the dimensions of the marking (i.e. length along the probe) as appears in the image, and use this to base an estimation for the length of the section inside the pocket.

Finally, at step 610, the depth is recorded in the patient's chart in an entry for the tooth determined at step 604. During a typical patient visit to a dental office, a health care practitioner will record the patient's current dental status, also known as a dental tooth charting. A dental status, or dental tooth chart, is a diagram depicting the human teeth, where each tooth in the diagram is marked to indicate an aspect of the tooth's condition. In examples, a marking may indicate that a tooth is missing, has had dental treatment in the past, has a carious lesion, or has periodontal disease. Such status is updated from time to time to reflect the patient's most up to date condition. This status may be recorded in an electronic medical records database.

The databases and modules disclosed herein may be any stored type of structured memory, including a persistent memory. In examples, this database may be implemented as a relational database or file system.

Identifiers, such as “(a),” “(b),” “(i),” “(ii),” etc., are sometimes used for different elements or steps. These identifiers are used for clarity and do not necessarily designate an order for the elements or steps.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A periodontal probe, comprising:
a light source;
a handle portion configured to enable a health care practitioner to grip the periodontal probe; and
a tip portion configured to be inserted into a pocket of a patient's gum tissue, the tip portion comprising:
a ruler comprising of a plurality of markings configured such that, when the periodontal probe is inserted into the patient's gum tissue, the markings indicate a depth of the pocket of the patient's gum tissue; and
a light transmission medium configured to transmit light emitted from the light source to an exterior surface of the tip portion, the light providing contrast to read the markings.

2. The periodontal probe of claim 1, wherein the light transmission medium is a translucent or transparent material.

3. The periodontal probe of claim 2, wherein the plurality of markings are applied using a coating on the light transmission medium.

4. The periodontal probe of claim 3, wherein the coating is applied to the light transmission medium to block the light emitted from the light source preventing the light's emission to the exterior surface of the tip portion at each of the plurality of markings.

5. The periodontal probe of claim 3, wherein the coating is applied to the light transmission material to allow the light emitted from the light source to emit to the exterior surface of the tip portion at each of the plurality of markings.

6. The periodontal probe of claim 5, wherein the coating is translucent and colored such at each of the plurality of markings emits light in a different color.

7. The periodontal probe of claim 5, wherein the plurality of markings emits light in a color distinct from a color palette of the patient's gum tissue.

8. The periodontal probe of claim 2, wherein the plurality of markings each emit light in a different color.

9. The periodontal probe of claim 1, wherein the light transmission medium is a plurality of light pipes, each of the plurality of light pipes transmitting light from the light source to a marking.

10. The periodontal probe of claim 1, wherein the handle portion comprises a power supply configured to power the light source, and wherein the tip portion is autoclavable and the handle portion is detachable from the tip portion.

11. The periodontal probe of claim 10, wherein the light source is configured to illuminate automatically when the handle portion is attached to the tip portion.

12. The periodontal probe of claim 1, wherein a first part of the handle portion comprises a power supply configured to power the light source and a second part of the handle portion does not, and wherein the first part is detachable from the tip portion and the second part of the handle portion, wherein the tip portion and the second part of the handle portion are autoclavable.

13. The periodontal probe of claim 1, wherein the light source is located within the handle portion.

14. The periodontal probe of claim 1, wherein the light source is located within the tip portion.

15. The periodontal probe of claim 1, further comprising a heat conductor configured to dissipate heat from the light source.

16. The periodontal probe of claim 1, further comprising the heat conductor comprises perforations.

17. A periodontal probe, comprising:
a handle portion configured to enable a health care practitioner to grip the periodontal probe;
a tip portion configured to be inserted into a pocket of a patient's gum tissue, the tip portion comprising a plurality of light transmission mediums each set to receive light at varying points along an exterior of the tip portion such that a number of light transmission mediums obscured by the patient's gum tissue corresponds to a depth of the pocket of the patient's gum tissue; and
at least one light sensor to detect light from the plurality of light transmission mediums.

18. The periodontal probe of claim 17, further comprising:
a module configured to (i) detect a contrast in intensity between adjacent light transmission mediums of the plurality of light transmission mediums and (ii) determine the depth of the pocket based on a detected contrast.

19. The periodontal probe of claim 18, wherein the module configured to determine the depth of the pocket based on the detected contrast such that, between a first and second adjacent light transmission medium of the plurality of light transmission mediums, the first adjacent light transmission medium receives a darker intensity of light and is determined to be within the pocket, and the second adjacent light transmission medium receives a lighter intensity of light and is determined to be outside the pocket.

20. The periodontal probe of claim 18, wherein the tip portion further comprises a light source positioned to emit light within the pocket, and wherein the module configured to determine the depth of the pocket based on the detected contrast such that, between a first and second adjacent light transmission medium of the plurality of light transmission mediums, the first adjacent light transmission medium receives a lighter intensity of light and is determined to be within the pocket, and the second adjacent light transmission medium receives a darker intensity of light and is determined to be outside the pocket.

21. The periodontal probe of claim 17, further comprising:
a module configured to transmit data collected from the at least one light sensor to (i) detect a contrast in intensity between adjacent light transmission mediums of the plurality of light transmission mediums and (ii) determine the depth of the pocket based on the detected contrast.

22. The periodontal probe of claim 17, wherein the tip portion comprises a flexible printed circuit board having the at least one light sensor.

23. The periodontal probe of claim 17, wherein each of the plurality of light transmission mediums is polycarbonate or optical acrylic.

24. The periodontal probe of claim 17, wherein each of the plurality of light transmission mediums is a light pipe connecting the exterior of the tip portion to the at least one light sensor.

25. The periodontal probe of claim 17, wherein each of the plurality of light transmission mediums is a light pipe connecting the exterior of the tip portion to the at least one light source.

26. The periodontal probe of claim 17, wherein the handle portion comprises a power supply configured to power the at least one light sensor, and wherein the tip portion is autoclavable and the handle portion is detachable from the tip portion.

27. The periodontal probe of claim 17, wherein a first part of the handle portion comprises a power supply configured to power the light source and a second part of the handle portion does not, and
wherein the first part is detachable from the tip portion and the second part of the handle portion,
wherein the tip portion and the second part of the handle portion are autoclavable.

28. The periodontal probe of claim 17, further comprising:
a module configured to transmit data collected from the at least one light sensor (i) to detect when all the plurality of light transmission mediums receive light and (ii) to send, in response to the detection in (i), a signal indicating that the health care practitioner will next measure another pocket of another tooth of the patient's mouth.

29. A computer-implemented method for measuring a depth of a pocket of a patient's gum, comprising:
(a) receiving an image captured from an intraoral camera, the image capturing a periodontal probe inserted into the patient's gum, the periodontal probe including a tip with a ruler comprising a plurality of markings;
(b) analyzing the image, using a computer vision algorithm, to identify which of a plurality of markings are obscured by the patient's gum; and
(c) determining, based on the markings identified in (b), the depth of the pocket of the patent's gum.

30. The method of claim 29, further comprising:
(d) determining which tooth of a patient's mouth corresponds to the pocket of the patient's gum; and
(e) recording in the patient's chart the depth in an entry for the tooth determined in (d).

31. The method of claim 29, wherein the image includes an image of a tooth corresponding to the pocket of the patient's gum, and wherein the determining (d) comprises applying a computer vision algorithm trained to detect the tooth.

32. The method of claim 29, wherein the intraoral camera is affixed to a dental mirror.

33. The method of claim 29, wherein the image is one of a frame of video capture from the intraoral camera.
